(19) United States
(12) Patent Application Publication
(10) Pub. No.: US 2016/0238205 A1
(43) Pub. Date: Aug. 18, 2016

(54) Collapsible Shelter Light

(71) Applicant: Concorde International, Plymouth, MN (US)

(72) Inventors: Jason Joseph Steigauf, Champlin, MN (US); Wade Randell Malcolm, Minneapolis, MN (US); John Titus Marlow, West St. Paul, MN (US)

(73) Assignee: Concorde International, Plymouth, MN (US)

(21) Appl. No.: 15/043,151

(22) Filed: Feb. 12, 2016

Related U.S. Application Data
(60) Provisional application No. 62/116,079, filed on Feb. 13, 2015.

(51) Int. Cl. F21S 9/00; F21V 23/06; F21V 31/00; F21V 23/00

(52) U.S. Cl. CPC F21S 9/00; F21V 23/003; F21V 23/06; F21V 31/005; F21Y 2101/02; F21Y 2113/00

(57) ABSTRACT

A light that integrates and easily connects to a structural portion of a shelter to produce a flood of light inside the shelter is described. A LED or similar light for a collapsible shelter may contain a relatively thin lighting source (chip on board, COB, module, traditional LED, and others) encircling a mounting channel, a lens or light transmissive covering to protect the lighting source, a control circuit to manage the power going to the lighting source, a housing to hold the internal components, a power source (internal or external), a seal to ensure the device is water and dust tight, an interface that can control the light source and a mount to affix to a structure. The structure may be a fish house, tent, canopy, etc.

### RELATED APPLICATIONS

This application claims priority to U.S. Provisional Application Ser. No. 62/116,079 entitled “COLLAPSIBLE SHELTER LIGHT” filed on Feb. 13, 2015 which is herein incorporated by reference.

### FIELD

The invention relates to collapsible shelters like fish houses, tents, pop up canopies, mobile garages, etc. that have a need for interior lighting to illuminate the space inside the shelter.

### BACKGROUND

There are many lanterns, string lighting, rope lighting options for collapsible shelters that allow the user to hang a light inside their shelter. While current shelter lights in the market are attachable in this way, they are not mountable so the shelter can be collapsed and the light does not need to be removed.

### BRIEF DESCRIPTION OF THE DRAWINGS

FIG. 1 is a perspective view of a lighting device secured onto a in a structural component of a shelter.

FIG. 2A is a top view of a complete construction of a light.

FIG. 2B is a side view of a complete construction of a light.

FIG. 2C is an isometric view of a complete construction of a light.

FIG. 3 is an exploded view of a complete construction of a light using a LED COB module with a switch.

FIG. 4 is an isometric view of an extended housing light.

FIG. 5 is an isometric view of a light with clip mounting.

FIG. 6 is an isometric view of a light with quick-detach mounting.

### DETAILED DESCRIPTION

In the following description, reference is made to the accompanying drawings that form a part hereof, and in which is shown by way of illustration, specific embodiments which may be practiced. These embodiments are described in sufficient detail to enable those skilled in the art to practice the invention, and it is to be understood that other embodiments may be utilized and that structural, logical and mechanical changes may be made without departing from the scope of the present invention. The following description of example embodiments is, therefore, not to be taken in a limited sense, and the scope of the present invention is defined by the appended claims.

According to various embodiments of the inventive subject matter, a lighting device is described which can be “hard mounted” in a shelter so the user does not have to continually set up a shelter, then attach the light. By securely affixing (meaning securely affixing with a fastener or other method that would require a threshold of effort to remove—as opposed to a hook or other temporary attachment) the light to the shelter and making it virtually integrated into the shelter construction, it appears to be a part of the shelter, offers excellent illumination, and eliminates the need for continual assembly/removal when the shelter is assembled/collapsed.

The inventive subject matter offers an affordable way to have LED lighting inside a shelter, securely mounted or/including being mounted in a way that the light could be removed and re-attached for added uses and storage. One design with a housing and lighting behind a tough polycarbonate (or similar material) lens, offers excellent light output and durability, which make it acceptable for use in a shelter that collapses and is stored. In addition the light may be configured varying color output in order to offer performance in different conditions (red light is easier on the eyes at night, blue light is easier to identify blood, etc.). The light can also be wired to an auxiliary battery or have an internal battery in the construction according to alternative embodiments.

The present teachings provide for a simple, durable shelter light that is easy to produce and has a very long operating life, particularly with the use of LEDs. The construction shown in the figures, using the COB module offers for a 120 degree light spread, which will offer excellent illumination inside a shelter, especially when mounted as a down light.

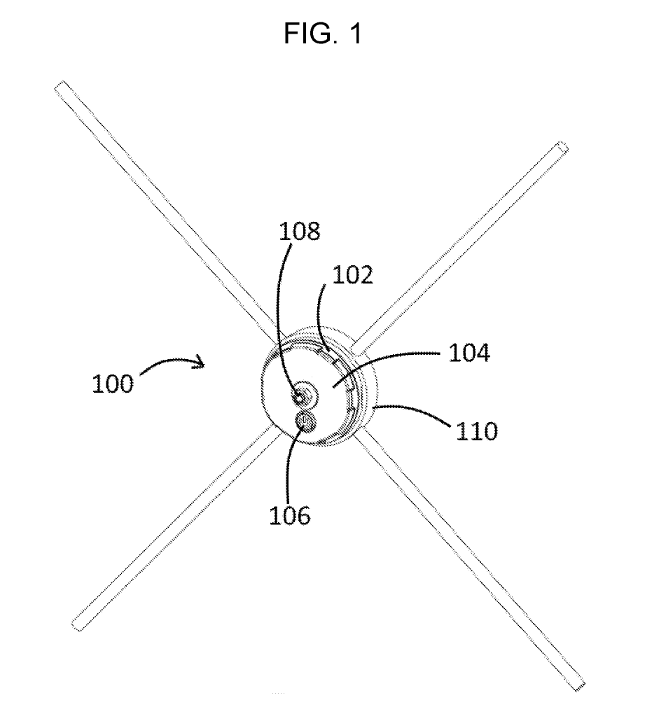

Referring to FIG. 1, according to various embodiments, the lighting device 100 includes a housing 102, a light transmissive cover 104, and a control button 106. Mounting hardware 108 secures the lighting device 100 to a structural element 110.

The housing 102 and light transmissive cover 104 have a central cavity allowing the mounting hardware 108 to pass through and secure the lighting device 100 to the structural element 110. The central cavity does not have to be exactly in the center of the lighting device 100, so long as it is within its perimeter. In this way, the mounting hardware 108 can be inserted through the cavity allowing a portion of the hardware to engage with the housing 102 and/or the light transmissive cover 104 to hold it in place. Example mounting hardware 108 includes a bolt and washer. The bolt would extend through the central cavity and thread into the structural element 110. When tightened, the bolt will squeeze the washer against the lighting device 100, providing a nice secure attachment to the structural element 110.

According to various embodiments, the hardware used to securely attach the lighting device 100 to the structural element is the hardware already present in the structural element. By providing a flange in the housing 102 or light transmissive cover 104 that resides in the central cavity near to the interface with the structural element, the use of a longer piece of hardware (e.g. bolt) is not necessary as the flange position allows for very minimal offset from the original depth of the structural element hardware.

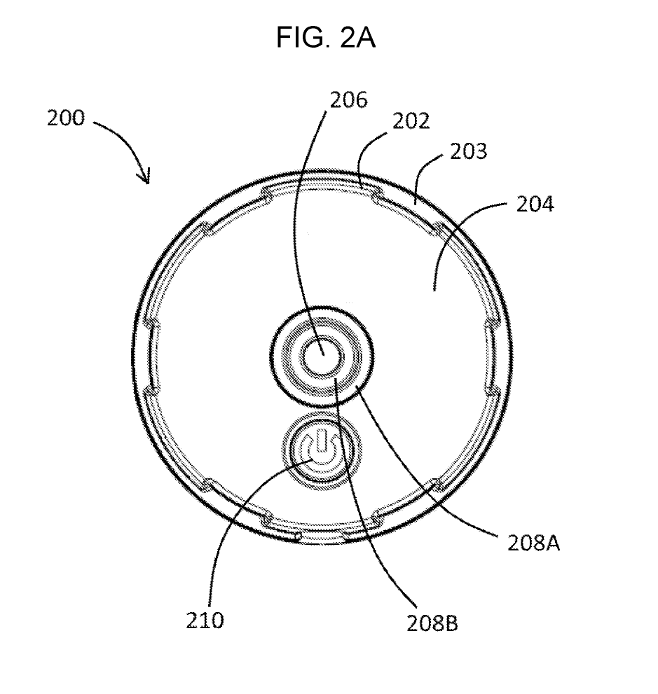

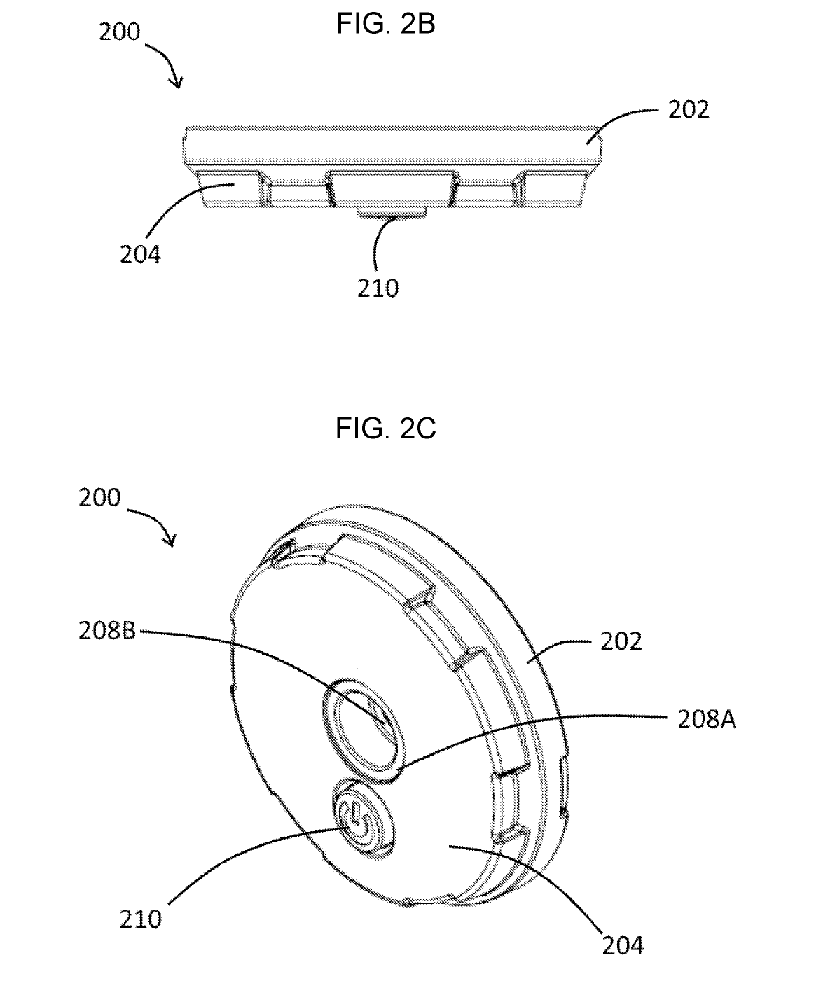

Referring to FIGS. 2A-2C, according to various embodiments, the lighting device 200 includes a housing with backplate 203 and cover 204, an aperture 206, a mounting flange 208A & 208B, and a control button 210. The backplate 203 is configured to be mounted against a structural element like a central hub in a shelter, or other element capable of accepting a fastener that would be provided through the aperture 206 to mount the lighting device to the element. The backplate 203 is generally flat in order to mount easily against another flat element, but may also have a curve or indentation arrangement in order to facilitate a smooth mounting with a similarly curved element or element with a protrusion pattern. The cover 204 engages with the backplate to provide a seal for the components internal to the housing. This seal may be moisture or dust restrictive as needed for the application of the lighting device according to various embodiments. Within the housing 202, internal circuitry and a lighting element reside. The cover 204 includes a light transmissive portion to allow light from the lighting element to illuminate the area exterior to the lighting device 200. The light transmissive portion may be completely transparent or partially transparent. The transparency may be provided with one or more levels of opacity. The light transmissive portion of the cover may take up the majority of the cover 204, or only select area(s). The light transmissive portion may be on the face and/or the sides of the cover. According to some embodiments, the cover 204 may extend from the backplate 203 to allow lighting elements to illuminate through light transmissive portions on the sides of the cover. By way of example, the cover 204 and the light transmissive portion may be made of a transparent and rugged material like polycarbonate. The cover 204 can be highly resistant to impact, making the construction very durable.

The aperture 206 is used to provide a path for a fastener to be inserted through the housing 202. The fastener can then engage with a mounting flange 208A/208B. The fastener may engage with the cover 202 via an upper mounting flange 208A, which would provide access to the fastener near the surface of the cover 204. The fastener may alternatively engage with the cover 204 or backplate 203 via a lower mounting flange 208B, which would allow for a shorter fastener and also hide the fastener within the cavity of the housing 202 forming the aperture 206. In this way, according to alternative embodiments, the mounting flange 208A/208B may be integrated into the cover 204 or the backplate 203 such that engagement with the mounting flange 208A/208B by a fastener allows for secure attachment of the housing 202.

According to various embodiments, a protector is provided additionally. The protector may engage with the housing 202 at the aperture 206. The protector may be shaped to fit partially within the aperture, enclosing the fastener, and providing a portion of the protector extending out of the aperture 206. This will allow the protector to take an impact that would have otherwise hit the housing. If the fastener is engaged near the surface of the cover 204, the protector may be attached to the head of the fastener to achieve the same result. The protector may be made of a resilient and/or shock absorbing material like a rubber, foam or flexible plastic for example.

The control button 210 may extend from the cover 204 to provide an interface for a user to control the lighting element within the housing 202. This control may include turning the lighting element on or off, providing levels of dimming, or providing varying light colors/wavelengths.

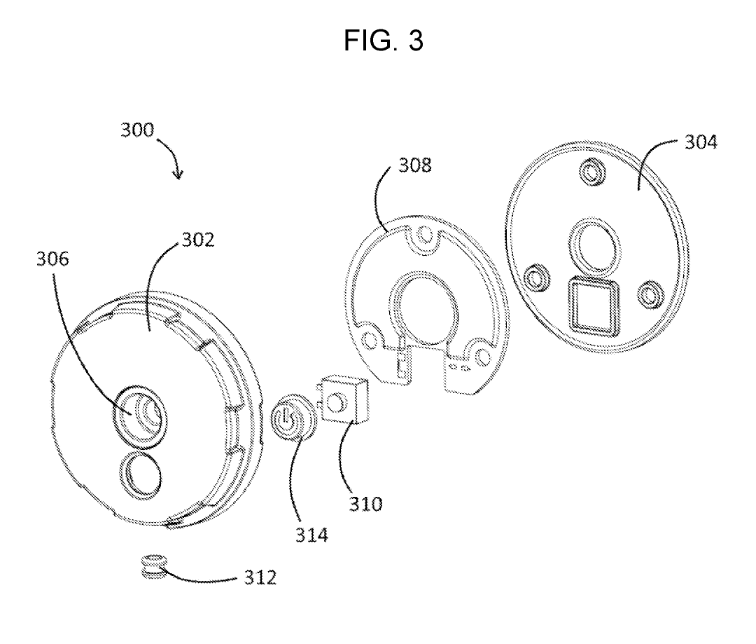

Referring to FIG. 3, according to various embodiments lighting device 300 is shown in an exploded view with cover 302, backplate 304, central aperture 306, lighting element 308, lighting control 310, wiring grommet 312 and interface 314. The cover 302 attaches to the backplate 304 in order to provide a sealed housing for the lighting control 310 and lighting element 308. If external wiring is used, a wiring grommet 312 or similar device is used to ensure that the housing is sealed where the wiring exits. The central aperture 306 is defined by the shaping of the cover 302 and backplate 304 and need not be located in the exact center of these elements. The central aperture 306 is defined by an axially aligned opening within the perimeters of the cover 302 and backplate 304. The use of this central aperture allows a fastener to securely mount the lighting device 300 to another object at a single point—a single mounting location.

The lighting element 308 may be mounted to the backplate 304 or to the cover 302. The lighting element 308 will shine light through a light transmissive portion of the cover 302. The cover 302 may be partially or totally light transmissive. The lighting element 308 is arranged within the lighting device 300 about the central aperture 306. Because the central aperture 306 exists within the housing defined by the cover 302 and backplate 304, the lighting element 308 is configured to encircle this central aperture 306. By encircling the central aperture 306, the lighting element 308 is able to provide an optimal amount of lighting surface area within the shape of the housing. Utilizing chip-on-board (COB) LED technology, a board may be provided and shaped to encircle the central aperture 306 with substantially continuous illumination about the surface of that board. When the lighting element 308 is described as encircling another component or opening within this description, such encirclement may be total or partial. According to various embodiments, the lighting element 308 encircles the central aperture 306 when a line can be drawn through the central aperture 306 that would pass through the lighting element 308 on both ends. The lighting element 308 includes one or more light emitting devices as well as the board or material supporting (physically and/or electronically) such light emitting devices. According to various embodiments, the shape of the lighting element 308 is determined by the position and size of the central aperture 306. A larger central aperture 306 will mean a skinnier lighting element 308 within the same sized housing. The position of the central aperture 306 will mean a differently shaped lighting element 308 will be provided.

The lighting element 308 may include one light emitting device or multiple of varying technologies, sizes or arrangements. The use of high or low intensity illumination may be present. As an example, high intensity illumination means the use of a high power LED for maximum light output such as surface mount LED chips. This could also mean the use of a high wattage halogen or HID bulb. In addition a blue laser focused on a yellow phosphorous could become a high intensity light source. As an example, low intensity illumination means lower output LEDs such as low power LEDs or COB modules (chip on board). COB modules involve printing several small LEDs directly onto a board, then potting over the chips with a transparent substrate that can be colored to change the output color of the LED. Additional low intensity illumination could be low wattage halogen bulbs. The lighting element 308 may, in various embodiments, consist of several different arrangement patterns of high and low intensity illumination as well, which could be used as a high/low feature in the performance. The light emitting devices in the lighting element 308 may additionally be arranged in various directions to obtain a desired light coverage area. If varying output lighting devices are used, high output devices may be activated when the user needs a lot of light and low output when the user needs minimal light. This could also be done to allow white light in one setting, and another color option, or a strobe function, etc. Reflectors and/or lenses can be added to the construction to help focus and direct the light. Light emitting devices capable of emitting differing wavelengths of light may be used as well. Different colored light may be useful depending on the circumstances. Different intensities may be useful as well—for battery preservation, user preference, or other situations.

The lighting control 310 is provided in electrical communication with the lighting element 308 to adjust the lighting element 308. According to various embodiments, adjustment of the lighting element 308 includes turning on the lighting element 308 on or off, dimming, switching between high and low intensity sources, and switching between wavelengths/colors emitted. The lighting control may be connected physically or electronically to an interface 314. The interface 314 may be a physical button to be manipulated by a used to adjust the lighting element 308. The interface 314 may also include sensors or other external input receptors in order to receive input to adjust the lighting element. As an example, the interface 314 may include an ambient light sensor to allow the lighting control 310 to turn off the lighting element 308 if there is a threshold amount of light already present, or turn on when a threshold amount of light is not present. As another example, the interface 314 may sense motion to control the lighting element 308. The interface 314 may include one or more controls (buttons, dimmers, or other electrical or mechanical interfaces) to signal the lighting control 310 to adjust the lighting element 308.

According to other embodiments, the lighting control 310 may communicate with an interface 314 that is integral to the cover 302. The cover 302 may be touched, depressed, rotated or otherwise manipulated, and such manipulation will serve as user input to the lighting control 308. The lighting control 308 will use that user input to adjust the lighting element 308.

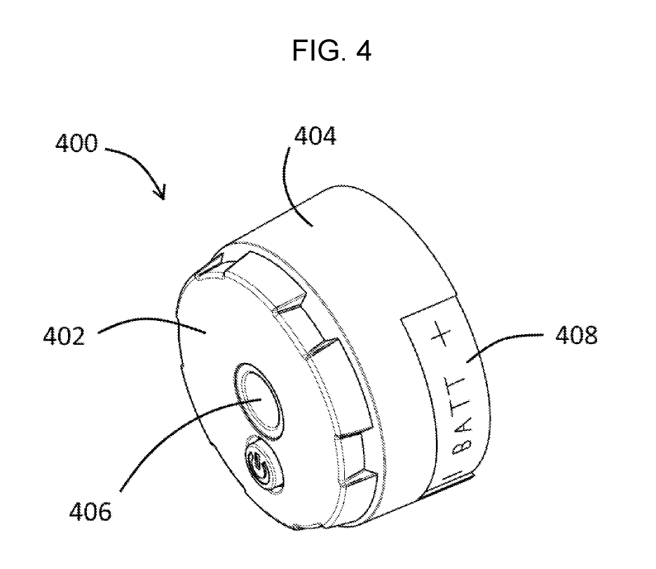

Referring to FIG. 4, according to various embodiments, the lighting device 400 includes a housing 402 having sides 404, and a central aperture 406. The housing 402 is provided with extended sides 404 in order to accommodate additional internal components, larger internal components, or varying lighting arrangements. The sides 404 may be light transmissive, allowing lighting elements provided within the housing 402 to provide illumination through the sides 404. An on-board battery may be provided within the housing in order to power the lighting elements. According to various embodiments, the battery may be accessible and replaceable through the use of a battery door 408.

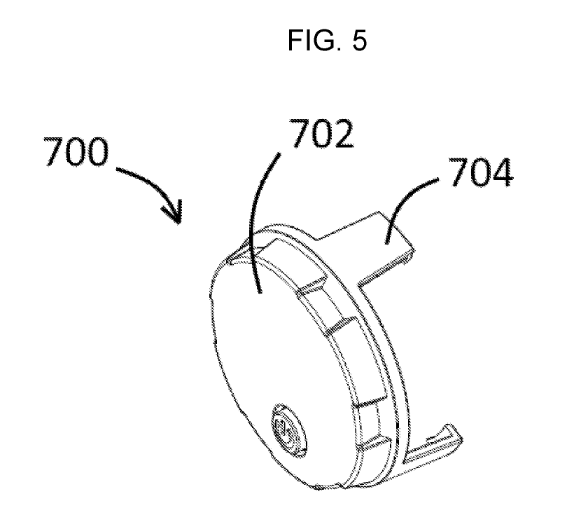

Referring to FIG. 5, according to various embodiments, the clip-mount lighting device 700 is shown with a housing 702 and mounting clips 704. The mounting clips 704 may be attached to or integrated into the housing 702. According to example embodiments, the mounting clips 704 are shaped and arranged to fit over a structural element of a shelter. The backside of the housing is shaped to interface with the structural element smoothly (e.g. having indentations available to cover protruding hardware). The mounting clips 704 may be adjustable in length or spacing in order to effectively and securely attach to one or more types/shapes/sizes of structural elements. A central hub on a collapsible fish house is a good example of a structural element. In such an example, the mounting clips 704 would wrap about the sides of the hub, clipping onto the backside, securing the clip-mount lighting device 700 to the shelter.

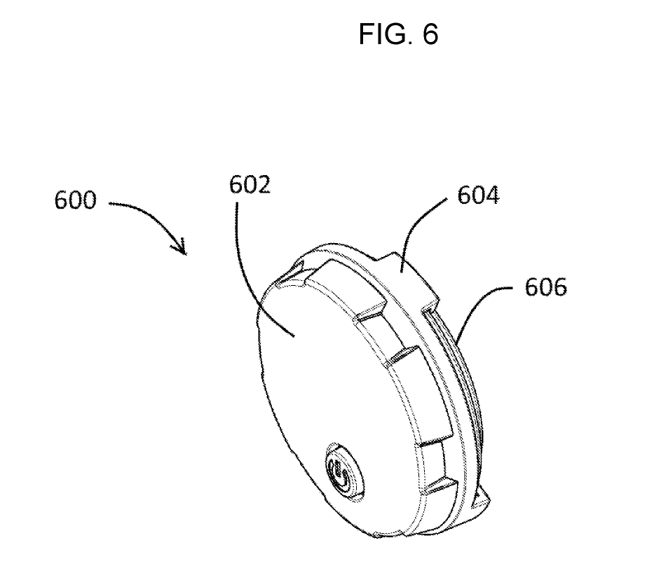

Referring to FIG. 6, according to various embodiments, a quick-detach lighting device 600 is shown with a housing 602, connector 604 and mounting plate 606. The mounting plate 606 is configured to be secured to a structural element. The mounting plate 606 may be securely attached with one or more fasteners. The mounting plate 606 may include an aperture and flange to allow a fastener (a bolt and washer for example) to pass through the aperture and thread into the structural element to secure the mounting plate 606 to the structural element.

The housing 602 may be provided with a connector 604 configured to easily engage with the mounting plate while allowing for quick removal. The connector 604 may utilize clips configured to engage with edges of the mounting plate 606. The mounting plate 606 may include an edge configured to receive the connector 604 clips and allow for easy detachment. The connector 604 may comprise other attachment mechanisms such as magnets, threading, hook-and-loop, twist-lock or other simple connection mechanisms to engage with the mounting plate 606.

According to various other embodiments, the mounting plate 606 includes electrical wiring that may be connected to an external power supply (e.g. battery). The connector 604 includes electrical connection components that are brought into electrical communication with electrical connection components on the mounting plate 606 such that electricity may be supplied to the quick-detach lighting device 700 when the connector 604 is secured to the mounting plate 606.

According to various other embodiments, the quick-detach lighting device 600 may be provided with an internal battery. When detached from the mounting plate 606, the quick-detach lighting device may be used for mobile illumination in a “flashlight-mode”, running off the battery. If electrical power is provided at the mounting plate, the battery may be charged when the connector 604 is in communication with the mounting plate 606 as described above.

Thus, example embodiments of the inventive subject matter are disclosed. One skilled in the art will appreciate that the present teachings can be practiced with embodiments other than those disclosed. High intensity LEDs are used as an exemplary lighting source, but it is considered that other high intensity or spot/flood beam lighting may be used as well. Similarly, LED COB modules are used as an exemplary lighting source, but it is considered that other lower intensity, flood, or other low-cost lighting source may be used as well. The disclosed embodiments are presented for purposes of illustration and not limitation, and the present teachings are limited only by the claims that follow.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A lighting apparatus comprising:
a housing having a light transmissive portion and a central cavity to allow passage of mounting hardware;
a mounting flange portion on the housing to engage with the mounting hardware to secure the housing to an external object; and
a lighting element within the housing arranged to provide light through the light transmissive portion of the housing;
wherein the lighting element encircles the central cavity.

2. The lighting apparatus of claim 1, wherein the lighting element provides continuous lighting about the majority of the perimeter of the central cavity.

3. The lighting apparatus of claim 1, further comprising a lighting control to adjust the lighting element.

4. The lighting apparatus of claim 3, further comprising a power connector in electrical communication with the lighting control, the power connector extending outside the housing.

5. The lighting apparatus of claim 1, further comprising a moisture seal on the housing to restrict moisture from entering the housing.

6. The lighting apparatus of claim 3, further comprising an interface to receive an input external to the housing, the interface in communication with the lighting control to allow the input external to the housing to direct adjustment of the lighting element.

7. A lighting apparatus comprising:
a backplate including a central aperture, a front side and a back side, the back side configured to be arranged in communication with a structural component of a shelter;
a light transmissive covering in communication with the backplate, the light transmissive covering having a central channel coaxial with the central aperture of the backplate;
a lighting element arranged upon the front side of the backplate, about the central aperture between the backplate and the light transmissive covering;
control circuitry in electrical communication with the lighting element and arranged between the light transmissive covering and the backplate; and
a mounting flange configured to engage with a fastener provided through the central aperture of the light transmissive covering and the central aperture of the backplate, the mounting flange further configured to affix the lighting apparatus to the structural component of a shelter with the fastener.

8. The lighting apparatus of claim 7, wherein the mounting flange is integrated with the light transmissive covering.

9. The lighting apparatus of claim 7, wherein the mounting flange is integrated with the backplate.

10. The lighting apparatus of claim 7, wherein the mounting flange is made up of a portion of the light transmissive covering and a portion of the backplate.

11. The lighting apparatus of claim 7, wherein the mounting flange includes a mounting aperture, the mounting aperture having a smaller diameter than the central aperture and the mounting aperture being coaxial with the central aperture;
wherein the mounting flange is configured to allow the fastener to be provided partially through the mounting aperture with a portion of the fastener unable to pass through the mounting aperture.

12. The lighting apparatus of claim 7, wherein the lighting element comprises a chip-on-board LED arrangement encircling the central aperture.

13. The lighting apparatus of claim 7, wherein the shape of the lighting element is defined by the central aperture.

14. An illuminating device comprising:
a housing having a central aperture;
a flange about the central aperture, the flange configured to accept a fastener to secure the housing to an external object at a single point;
a lighting element enclosed within the housing, the lighting element encircling the central aperture; and
a lighting control within the housing, the lighting control electrically connected to the lighting element;
wherein the lighting control is configured to adjust the lighting element based on an input external to the housing.

15. The illuminating device of claim 14, wherein the lighting element comprises a chip-on-board module to provide light based on input from the lighting control.

16. The illuminating device of claim 14, further comprising a reflector within the housing adjacent to the lighting element.

17. The illuminating device of claim 14, wherein the lighting element further comprises:
a first lighting source, the first lighting source providing a high intensity illumination; and
a second lighting source, the second lighting source providing a low intensity illumination;
wherein the first lighting source and the second lighting source are arranged within the housing to selectively provide illumination based on input from the lighting control.

18. The illuminating device of claim 14, further comprising a power source in communication with the lighting control, the power source arranged within the housing.

19. The illuminating device of claim 14, wherein the housing further comprises a light transmissive cover;
wherein the flange is integrated into the light transmissive cover.

20. The illuminating device of claim 14, wherein the housing further comprises a backplate;
wherein the flange is integrated into the backplate.
